(19) United States
(12) Patent Application Publication
(10) Pub. No.: US 2013/0098011 A1
(43) Pub. Date: Apr. 25, 2013

(54) HYDRAULIC SYSTEM HAVING MULTIPLE CLOSED-LOOP CIRCUITS

(71) Applicants: Michael L. KNUSSMAN, East Peoria, IL (US); Magomed O. Gabibulayev, Dunlap, IL (US)

(72) Inventors: Michael L. KNUSSMAN, East Peoria, IL (US); Magomed O. Gabibulayev, Dunlap, IL (US)

(21) Appl. No.: 13/278,650

(22) Filed: Oct. 21, 2011

(51) Int. Cl. F15B 11/17

(52) U.S. Cl. 60/327; 60/428

(57) ABSTRACT

A hydraulic system is disclosed. The hydraulic system may have a first circuit fluidly connecting a first pump to a swing motor in a closed-loop manner, and a second circuit fluidly connecting a second pump to a first travel motor and a first linear tool actuator in a parallel closed-loop manner. The hydraulic system may also have a combining valve configured to selectively fluidly connect the first circuit to the second circuit.

### TECHNICAL FIELD

The present disclosure relates generally to a hydraulic system and, more particularly, to a closed-loop hydraulic system having multiple closed-loop circuits.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount. In contrast, to move the same or another actuator at a low speed, the restriction placed on the flow of fluid is increased. Although adequate for many applications, the use of fluid restriction to control actuator speed can result in pressure losses that reduce an overall efficiency of a hydraulic system.

An alternative type of hydraulic system is known as a closed-loop hydraulic system. A closed-loop hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator(s) with a lower speed, the pump discharges the fluid at a slower rate. A closed-loop hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and no throttling of a fluid flow is required.

An exemplary closed-loop hydraulic system is disclosed in U.S. Pat. No. 4,369,625 of Izumi et al. that published on Jan. 25, 1983 (the '625 patent). In the '625 patent, a multi-actuator meterless-type hydraulic system is described that has flow combining functionality. The hydraulic system includes a swing circuit, a boom circuit, a stick circuit, a bucket circuit, a left travel circuit, and a right travel circuit. Each of the swing, boom, stick, and bucket circuits have a pump connected to a specialized actuator in a closed-loop manner. In addition, a first combining valve is connected between the swing and stick circuits, a second combining valve is connected between the stick and boom circuits, and a third combining valve is connected between the bucket and boom circuits. The left and right travel circuits are connected in parallel to the pumps of the bucket and boom circuits, respectively. In this configuration, any one actuator can receive pressurized fluid from more than one pump such that its speed is not limited by the capacity of a single pump.

Although an improvement over existing closed-loop hydraulic systems, the closed-loop hydraulic system of the '625 patent described above may still be less than optimal. In particular, operation of connected circuits of the system may only be sequentially performed. In addition, the speeds and forces of the various actuators may be difficult to control.

The hydraulic system of the present disclosure is directed toward solving one or more of the problems set forth above and/or other problems of the prior art.

### SUMMARY

In one aspect, the present disclosure is directed to a hydraulic system. The hydraulic system may include a first circuit fluidly connecting a first pump to a swing motor in a closed-loop manner, and a second circuit fluidly connecting a second pump to a first travel motor and to a first linear tool actuator in a parallel closed-loop manner. The hydraulic system may also include a combining valve configured to selectively fluidly connect the first circuit to the second circuit.

In another aspect, the present disclosure is directed to a method of operating a hydraulic system. The method may include pressurizing fluid with a first pump and a second pump. The method may also include directing fluid from the first pump to a swing motor and from the swing motor back to the first pump in a closed-loop manner, and directing fluid from the second pump to a first linear actuator and to a first travel motor in parallel and from the first linear actuator and travel motor back to the second pump in a closed-loop manner. The method may additionally include selectively combining fluid from the first circuit with fluid from the second circuit.

### BRIEF DESCRIPTION OF THE DRAWINGS

FIG. 1 is a pictorial illustration of an exemplary disclosed machine;

FIG. 2 is a schematic illustration of an exemplary disclosed hydraulic system that may be used in conjunction with the machine of FIG. 1;

FIG. 3 is a schematic illustration of another exemplary disclosed hydraulic system that may be used in conjunction with the machine of FIG. 1; and

FIG. 4 is a schematic illustration of yet another exemplary disclosed hydraulic system that may be used in conjunction with the machine of FIG. 1.

### DETAILED DESCRIPTION

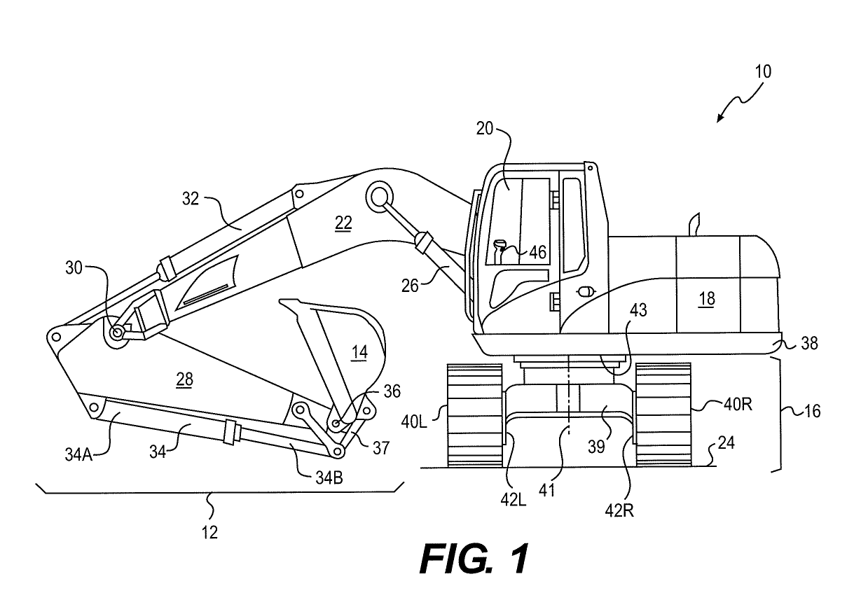

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected to a body 38 of machine 10. Body 38 may be pivotally connected to an undercarriage 39 and movable about a vertical axis 41 by a hydraulic swing motor 43. Stick 28 may pivotally connect boom 22 to work tool 14 by way of axis 30 and 36.

Numerous different work tools 14 may be attachable to a single machine 10 and operator controllable. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left-travel motor 42L, while right track 40R may be driven by a right-travel motor 42R. It is contemplated that drive system 16 could alternatively include traction devices other than tracks such as wheels, belts, or other known traction devices. Machine 10 may be steered by generating a speed and/or rotational direction difference between left and right-travel motors 42L, 42R, while straight travel may be facilitated by generating substantially equal output speeds and rotational directions from left and right-travel motors 42L, 42R.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34 and left travel, right travel, and swing motors 42L, 42R, 43.

Operator station 20 may include devices that receive input from a machine operator indicative of desired machine maneuvering. Specifically, operator station 20 may include one or more operator interface devices 46, for example a joystick, a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

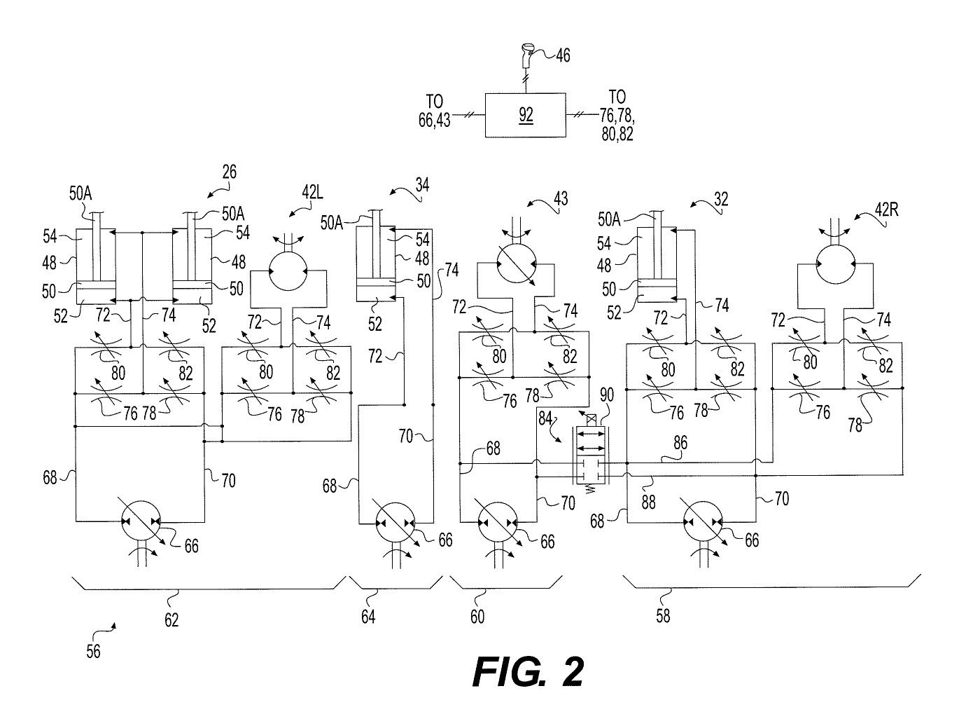

As shown in FIG. 2, hydraulic cylinders 26, 32, 34 may each include a tube 48 and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26, 32, 34, while first chamber 52 may be considered the head-end chamber.

First and second chambers 52, 54 may each be selectively supplied with pressurized fluid and drained of the pressurized fluid to cause piston assembly 50 to displace within tube 48, thereby changing an effective length of hydraulic cylinders 26, 32, 34 and moving work tool 14 (referring to FIG. 1). A flow rate of fluid into and out of first and second chambers 52, 54 may relate to a translational velocity of hydraulic cylinders 26, 32, 34, while a pressure differential between first and second chambers 52, 54 may relate to a force imparted by hydraulic cylinders 26, 32, 34 on the associated linkage structure of implement system 12.

Swing motor 43, like hydraulic cylinders 26, 32, 34, may be driven by a fluid pressure differential. Specifically, swing motor 43 may include first and second chambers (not shown) located to either side of a pumping mechanism such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine an output velocity of swing motor 43, while a pressure differential across the pumping mechanism may determine an output torque. It is contemplated that a displacement of swing motor 43 may be variable and of an over-center type (with controls and equipment to support a load when changing displacement directions), if desired, such that for a given flow rate and/or pressure of supplied fluid, a speed and/or torque output of swing motor 43 may be adjusted.

Similar to swing motor 43, each of left and right-travel motors 42L, 42R may be driven by creating a fluid pressure differential. Specifically, each of left and right-travel motors 42L, 42R may include first and second chambers (not shown) located to either side of a pumping mechanism (not shown). When the first chamber is filled with pressurized fluid and the second chamber is drained of fluid, the pumping mechanism may be urged to move or rotate a corresponding traction device (40L, 40R) in a first direction. Conversely, when the first chamber is drained of the fluid and the second chamber is filled with the pressurized fluid, the respective pumping mechanism may be urged to move or rotate the traction device in an opposite direction. The flow rate of fluid into and out of the first and second chambers may determine a velocity of left and right-travel motors 42L, 42R, while a pressure differential between left and right-travel motors 42L, 42R may determine a torque. It is contemplated that a displacement of left and right-travel motors 42L, 42R may be variable, if desired, such that for a given flow rate and/or pressure of supplied fluid, a speed and/or torque output of travel motors 42L, 42R may be adjusted.

As illustrated in FIG. 2, machine 10 may include a hydraulic system 56 having a plurality of circuits that drive the fluid actuators described above to move work tool 14 (referring to FIG. 1) and machine 10. In particular, hydraulic system 56 may include, among other things, a first circuit 58, a second circuit 60, a third circuit 62, and a fourth circuit 64. First circuit 58 may be associated with hydraulic cylinder 32 and right-travel motor 42R and, at select times, with swing motor 43. Second circuit 60 may be associated with swing motor 43 and, at select times, with hydraulic cylinder 32 and right-travel motor 42R. Third circuit 62 may be associated with hydraulic cylinders 26 and left-travel motor 42L. Fourth circuit 64 may be associated with hydraulic cylinder 34. It is contemplated that additional and/or different configurations of circuits may be included within hydraulic system 56 such as, for example, a charge circuit associated with each of circuits 58-62 or an independent circuit associated with each separate actuator (e.g., hydraulic cylinders 32, 34, 26, left-travel motor 42L, right-travel motor 42R, and/or swing motor 43), if desired.

In the disclosed embodiment, each of circuits 58-64 may be similar and include a plurality of interconnecting and cooperating fluid components that facilitate the use and control of the associated actuators. For example, each circuit 58-64 may include a pump 66 fluidly connected to its associated actuator(s) via a closed-loop formed by left-side and right-side (relative to FIG. 2) passages. Specifically, each of circuits 58-64 may include a common left pump passage 68, a common right pump passage 70, a left actuator passage 72 for each actuator, and a right actuator passage 74 for each actuator. In circuits having linear actuators (e.g., hydraulic cylinders 26, 32, or 34), left and right actuator passages 72, 74 may be commonly known as head-end and rod-end passages, respectively. Within each circuit 58-66, the corresponding pump 66 may be connected to its associated actuators via a combination of left and right, pump and actuator passages 68-74.

To cause a rotary actuator (e.g., left-travel, right-travel, or swing motor 42L, 42R, 43) to rotate in a first direction, left pump passage 68 of a particular circuit may be filled with fluid pressurized by pump 66, while the corresponding right pump passage 70 may be filled with fluid exiting the rotary actuator. To reverse direction of the rotary actuator, right pump passage 70 may be filled with fluid pressurized by pump 66, while left pump passage 68 may be filled with fluid exiting the rotary actuator.

To extend a linear actuator (e.g., hydraulic cylinders 26, 32, or 34), second actuator passage 74 of a particular circuit may be filled with fluid pressurized by pump 66, while corresponding left actuator passage 72 may be filled with fluid returned from the linear actuator. In contrast, to retract the linear actuator, left actuator passage 72 may be filled with fluid pressurized by pump 66, while second actuator passage 74 may be filled with fluid exiting the linear actuator.

Each pump 66 may have variable displacement and be controlled to draw fluid from its associated actuators and discharge the fluid at a specified elevated pressure back to the actuators in two different directions. That is, pump 66 may include a stroke-adjusting mechanism, for example a swashplate, a position of which is hydro-mechanically adjusted based on, among other things, a desired speed of the actuators to thereby vary an output (e.g., a discharge rate) of pump 66. The displacement of pump 66 may be adjusted from a zero displacement position at which substantially no fluid is discharged from pump 66, to a maximum displacement position in a first direction at which fluid is discharged from pump 66 at a maximum rate into left pump passage. Likewise, the displacement of pump 66 may be adjusted from the zero displacement position to a maximum displacement position in a second direction at which fluid is discharged from pump 66 at a maximum rate into right pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pumps 66 of different circuits may be connected to power source 18 in tandem (e.g., via the same shaft) or in parallel (via a gear train), as desired.

Pumps 66 of the different circuits may have different capacities depending on the particular actuators connected to each circuit. For example, pump 66 of first circuit 58 may have the smallest capacity of any of pumps 66, as the actuators of first circuit 58 may have the lowest demand for fluid. In contrast, pump 66 of third circuit 62 may have the greatest capacity of any of pumps 66, as the actuators in third circuit 62 may have the greatest demands for fluid. Pumps 66 of second and fourth circuits 60, 64 may each have a capacity less than the capacity of pump 66 of third circuit 62, but about twice the capacity of pump 66 from first circuit 58. In the disclosed embodiment, pump 66 of first circuit 58 may have a capacity to discharge fluid at a maximum rate of about 112 liters per min (lpm). Pumps 66 of second and fourth circuits 60, 64 may each have a capacity of about 210 lpm, while pump 66 of third circuit 62 may have a capacity of about 377 lpm.

Pumps 66 may also be selectively operated as motors. More specifically, when an associated actuator is operating in an overrunning condition, the fluid discharged from the actuator may have a pressure elevated higher than an output pressure of the corresponding pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

During some operations, it may be desirable to cause movement of a linear actuator independent of movement of the associated rotary actuator within the same circuit. For this purpose, each of circuits 58, 60, and 62 may be provided with at least one metering valve for each actuator that is capable of substantially isolating one actuator from its associated pump 66 and/or other actuators of the same circuit, and also capable of independently controlling a speed of the associated actuator. In the disclosed embodiment, each of circuits 58, 60, and 62 may include a set of four independent metering valves for each actuator, including a first metering valve 76, a second metering valve 78, a third metering valve 80, and a fourth metering valve 82. First and second metering valves 76, 78 may be configured to regulate fluid flow into and out of one side of the associated actuator (e.g., into and out of second chamber 54 of a linear actuator). Third and fourth metering valves 80, 82 may be configured to similarly control fluid flow into and out of a second side of the associated actuator (e.g., into and out of first chamber 52). First and third metering valves 76, 80 may be associated with left pump passage, while second and fourth metering valves 78, 82 may be associated with right pump passage 70. During operation, one of first and second metering valves 76, 78 and one of third and fourth metering valves 80 82 will generally be passing fluid, while the remaining valves will generally be blocking fluid flow. And of the valves that are passing fluid, one will generally be passing fluid into the associated actuator, while the other will generally be passing fluid out of the associated actuator. In this manner, each set of four metering valves 76-82 may be utilized together to control a speed (through variable restriction of supply and return fluid flows) and a movement direction (through selective control of which of the valves are passing and blocking flow) of the associated actuator.

Each metering valve 76-82 may include a valve element movable to any position between a fully-open or flow-passing position and a fully-closed or flow-blocking position. Each metering valve 76-82 may be spring-biased toward the flow-blocking position and solenoid-operated to move toward the flow-passing position. It is contemplated that other configurations of valves may be utilized to meter fluid into and/or out of the actuators of hydraulic system 56, if desired, such as a common spool valve associated with each side of individual actuators or a single spool valve for each actuator, as desired.

Fourth circuit 64 may be considered a completely meterless circuit. In particular, hydraulic cylinder 34 may be controlled solely through regulation of its paired pump 66. For example, to extend hydraulic cylinder 34 at a higher speed, pump 66 may discharge fluid at a faster rate into left pump passage. Similarly, to retract hydraulic cylinder 34 with a lower speed, pump 66 may discharge fluid at a slower rate into right pump passage 70. In this manner, a displacement and rotational direction of pump 66 may be utilized to control a speed and movement direction of hydraulic cylinder 34, without metering of the fluid.

In some embodiments, metering valves 76-82 may be used to facilitate fluid regeneration within the associated linear actuator. For example, when metering valves 76 and 80 are simultaneously moved to their flow-passing positions and metering valves 78 and 82 are in their flow-blocking positions, high-pressure fluid may be transferred from one chamber to the other of the linear actuator via metering valves 76 and 80, with only the rod volume of fluid (i.e., the volume displaced by rod portion 50A that is about equal to a difference between a first chamber volume and a second chamber volume) ever passing through pump 66. Similar functionality may alternatively be achieved by moving metering valves 78 and 82 to their flow-passing positions while holding metering valves 76 and 80 in their flow-blocking positions.

In some situations, it may be desirable to combine fluid from one circuit with fluid from another circuit to increase a flow rate of fluid directed to and a resulting speed of a particular actuator. For example, there may be situations where the capacity of pump 66 of first circuit 58 is too low to supply a combined demand for pressurized fluid from hydraulic cylinder 32 and right-travel motor 42R. There may also be situations where the capacity of pump 66 of second circuit 60 is too low for a maximum demand for pressurized fluid from swing motor 43. In these situations, it may be helpful to combine fluid flows from pumps 66 of both first and second circuits 58, 60 and to direct the combined flows to hydraulic cylinder 34, right-travel motor 42R, or swing motor 43 to increase a speed of the particular actuator. For this reason, hydraulic system 56 may be provided with a combining valve 84.

Combining valve 84 may be configured to control fluid flow within a first common passage 86 that extends between left pump passages 68 of first and second circuits 58, 60, and within a second common passage 88 that extends between right pump passages 70. In the embodiment of FIG. 2, combining valve 84 may include a single variable-position valve element 90 that is movable to any position between a first or flow-blocking position (shown in FIG. 2) and a second or flow-passing position. Valve element 90 may be spring-biased toward the first position and solenoid-operated to move toward the second position. When valve element 90 is in the first position, first circuit 58 may be substantially isolated from second circuit 60. When valve element 90 is in the second position, fluid may flow freely between left pump passages 68 and between right pump passages 70 of first and second circuits 58, 60. A direction of flow through combining valve 84 may be determined, at least in part, by a pressure differential between first and second circuits 58, 60.

During operation of machine 10, the operator may utilize interface device 46 to provide a signal that identifies a desired movement of the various linear and/or rotary actuators to a controller 92. Based upon one or more signals, including the signal from interface device 46 and, for example, signals from various pressure sensors and/or position sensors located throughout hydraulic system 56, controller 92 may command movement of the different valves and/or displacement changes of the different pumps and motors to advance a particular one or more of the linear and/or rotary actuators to a desired position in a desired manner (i.e., at a desired speed and/or with a desired force).

Controller 92 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 92. It should be appreciated that controller 92 could readily be embodied in a general machine microprocessor capable of controlling numerous machine functions. Controller 92 may include a memory, a secondary storage device, a processor, and any other components for running an application. Various other circuits may be associated with controller 92 such as power supply circuitry, signal conditioning circuitry, solenoid driver circuitry, and other types of circuitry.

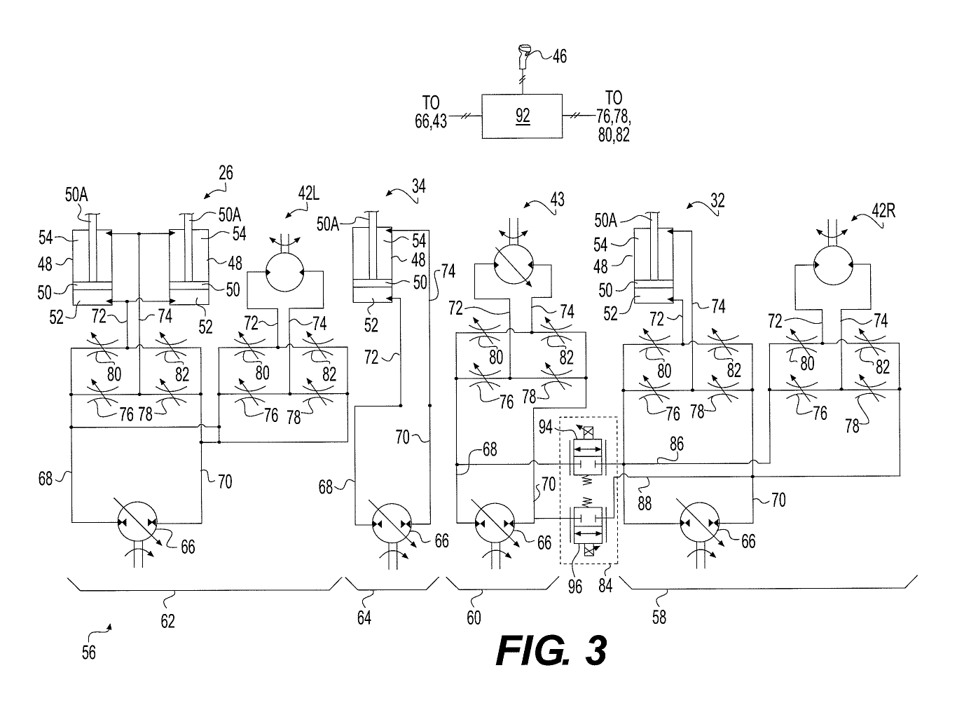

FIG. 3 illustrates an alternative embodiment of hydraulic system 56. Like the embodiment of FIG. 2, hydraulic system of FIG. 3 includes first, second, third, and fourth circuits 56-64 that function in closed-loop manner. In contrast to the embodiment of FIG. 2, however, combining valve 84 of FIG. 3 may have a different configuration. In particular, combining valve 84 may include two separate, but substantially identical, valve elements 94 and 96. Each of valve elements 94, 96 may be variable-position elements that are spring-biased toward flow-blocking positions and solenoid-operated to move to any position between a flow-blocking position and a flow-passing position. Valve element 94 may be associated with first common passage 86, while second valve element 96 may be associated with second common passage 88. Combining valve 84 of FIG. 3 may allow for reduced throttling loss and enhanced controllability through independent flow modulation of first and second common passages 86, 88.

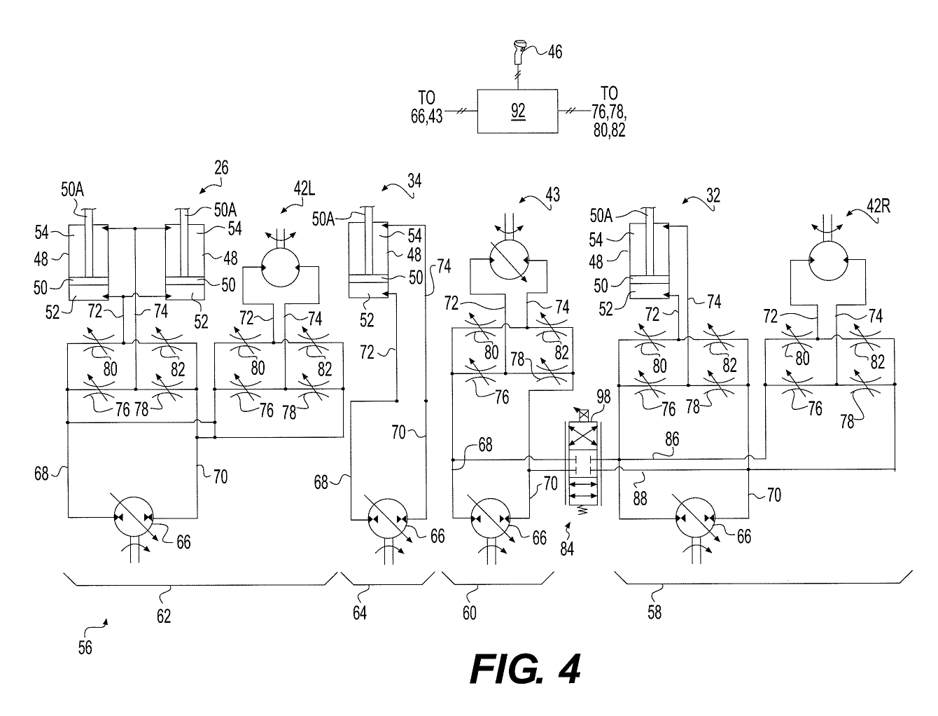

FIG. 4 illustrates another alternative embodiment of hydraulic system 56. Like the embodiments of FIGS. 2 and 3, hydraulic system of FIG. 3 also includes first, second, third, and fourth circuits 56-64 that function in closed-loop manner. In contrast to the embodiments of FIGS. 2 and 3, however, combining valve 84 of FIG. 4 may have another configuration. In particular, combining valve 84 may include a single valve element 98 that is movable to any position between three distinct positions. When valve element 98 is in a first position, left pump passages 68 of first and second circuits 58, 60 may be fluidly connected with each other via first common passage 86 and right pump passages 70 may be fluidly connected with each other via second common passage 88. When valve element 98 is in a second position, left pump passages 68 of first circuit 58 may be fluidly connected with right pump passage 70 of second circuit 60 and right pump passage 70 of first circuit 58 may be fluidly connected with left pump passage of second circuit 60. When valve element 98 is in a third (middle) position, fluid flow through combining valve 84 may be blocked such that first circuit 58 may be substantially isolated from second circuit 60. Combining valve 84 of FIG. 4 may allow for enhanced efficiency by enabling the combining of like and opposing loads during situations where pumps 66 of first and second circuits 58, 60 are switching flow directions (i.e., during situations where first and right pump passages 68, 70 within one or both of first and second circuits 58, 60 is switching between high and low relative pressures).

### INDUSTRIAL APPLICABILITY

The disclosed hydraulic system may be applicable to any machine where improved hydraulic efficiency and performance is desired. The disclosed hydraulic system may provide for improved efficiency through the use of closed-loop and meterless technology. The disclosed hydraulic system may provide for enhanced functionality and control through the selective use of novel circuit and flow-combining configurations. Operation of hydraulic system 56 will now be described.

During operation of machine 10, an operator located within station 20 may command a particular motion of work tool 14 in a desired direction and at a desired velocity by way of interface device 46. One or more corresponding signals generated by interface device 46 may be provided to controller 92 indicative of the desired motion, along with machine performance information, for example sensor data such a pressure data, position data, speed data, pump displacement data, and other data known in the art.

In response to the signals from interface device 46 and based on the machine performance information, controller 92 may generate control signals directed to pumps 66, motors 42L, 42R, and 43, and/or to valves 76, 78, 80, 82, 90. For example, to rotate right-travel motor 42R at an increasing speed in the first direction, controller 92 may generate a control signal that causes pump 66 of first circuit 58 to increase its displacement and discharge fluid into left pump passage at a greater rate. In addition, controller 92 may generate a control signal that causes metering valves 76 and 82 to move a greater extent toward and/or remain in their flow-passing positions. After fluid from pump 66 passes into and through right-travel motor 42R via left pump passage, the fluid may return to pump 66 via right pump passage 70. At this time, the speed of right-travel motor 42R may be dependent on a discharge rate of pump 66 and on a restriction amount, if any, provided by metering valves 76 and 82 on the flow of fluid passing through right-travel motor 42R. Movement of hydraulic cylinder 32 in a first direction (e.g., in a retracting direction) may be implemented in a similar manner.

The motion of right-travel motor 42R may be reversed in two different ways. First, the output direction of pump 66 may be reversed, thereby reversing a flow direction of fluid passing from pump 66 through first circuit 58 and right-travel motor 42R. Alternatively, metering valves 76 and 82 may be moved to their flow-blocking positions and metering vales 78, 80 simultaneously moved an extent toward their flow-passing positions such that, although the flow direction of fluid within first circuit 58 may remain the same, the flow direction through right-travel motor 42R may be reversed. Movement of hydraulic cylinder 32 in a second direction (e.g., in an extending direction) may be implemented in a similar manner.

When the operator desires to simultaneously move multiple actuators within a single circuit, speed and direction control of the actuators may be independently controlled by metering fluid into and out of at least one of the actuators. In particular, pump control (displacement and directional output control) may only be used to independently regulate the speed and direction of one actuator within a common circuit. And in order to independently regulate the speed and direction of remaining actuator(s) within the same circuit, metering valves 76-82 associated with the actuator(s) must be used to independently switch movement directions of the actuator(s) and to independently regulate flow rates into and out of the actuator(s) through throttling. It is contemplated that the metering valves 76-82 of all actuators within a single circuit may be utilized, if desired, to independently control the movement directions and speeds. Although throttling the fluid flows through all actuators of a single circuit may adequately control the movement directions and speeds of the actuators, this throttling may result in a lower efficiency of hydraulic system 56. To help reduce throttling, actuators that infrequently operate simultaneously may be paired together with a single pump 66.

Operation of hydraulic cylinders 26 and 34 and of left-travel and swing motors 42L, 43 may be implemented in a similar manner to that described above. Accordingly detailed description of the individual movements of these actuators will be not be described in this disclosure.

During some operations, the flow rate of fluid provided to individual actuators from their associated pumps 66 may be insufficient to meet operator demands. For example, during a swinging operation, an operator may request a swinging speed of machine 10 the would require a flow rate of fluid within second circuit 60 that exceeds the capacity of the associated pump 66. During this situation, controller 92 may cause the valve element(s) of combining valve 84 to pass fluid from first circuit 58 to second circuit 60, thereby increasing the flow rate of fluid passing through swing motor 43. At this time, fluid discharging from swing motor 43 may be returned to pump 66 of second circuit 60 and to pump 66 of first circuit 58 via combining valve 84. This operation may be similarly implemented when a fluid demand for hydraulic cylinder 32 and/or right-travel motor 42R exceeds a capacity of pump 66 within first circuit 58 and/or when an amount of fluid discharged from hydraulic cylinder 32 exceeds a rate at which pump 66 can consume return fluid.

In the disclosed embodiments of hydraulic system 56, flows provided by pumps 66 may be substantially unrestricted during many operations such that significant energy is not unnecessarily wasted in the actuation process. Thus, embodiments of the disclosure may provide improved energy usage and conservation. In addition, the ability to combine fluid flows from different circuits to satisfy demands of individual actuators may allow for a reduction in the number of pumps required within hydraulic system 56 and/or a size and capacity of these pumps. These reductions may reduce pump losses, improve overall efficiency, improve packaging of hydraulic system 56, and/or reduce a cost of hydraulic system 56.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a first circuit fluidly connecting a first pump to a swing motor in a closed-loop manner;
a second circuit fluidly connecting a second pump to a first travel motor and a first linear tool actuator in a parallel closed-loop manner; and
a combining valve configured to selectively fluidly connect the first circuit to the second circuit.

2. The hydraulic system of claim 1, further including a third circuit fluidly connecting a third pump to tandem-operating second linear tool actuators and to a second travel motor in a parallel closed-loop manner.

3. The hydraulic system of claim 2, further including a fourth circuit fluidly connecting a fourth pump to a third linear tool actuator in closed-loop manner.

4. The hydraulic system of claim 3, further including:
at least a first metering valve associated with the swing motor;
at least a second metering valve associated with the first linear tool actuator;
at least a third metering valve associated with the first travel motor;
at least a fourth metering valve associated with the second linear tool actuators; and
at least a fifth metering valve associated with the second travel motor.

5. The hydraulic system of claim 4, wherein the at least a first, at least a second, at least a third, and least a fourth, and at least a fifth metering valves each includes a set of four independent metering valves.

6. The hydraulic system of claim 4, wherein the fourth circuit is a meterless circuit.

7. The hydraulic system of claim 3, wherein the first pump has a capacity of about half of a capacity of the second pump and about a third a capacity of the third pump.

8. The hydraulic system of claim 7, wherein the second and fourth pumps have about equal capacities.

9. The hydraulic system of claim 8, wherein each of the first, second, third, and fourth pumps are over-center variable-displacement pumps.

10. The hydraulic system of claim 9, wherein each of the first and second travel motors are fixed displacement motors.

11. The hydraulic system of claim 10, wherein the swing motor is an over-center variable-displacement motor.

12. The hydraulic system of claim 3, wherein each of the swing motor, first travel motor, first linear actuator, second linear actuators, and third linear actuator are simultaneously operable.

13. The hydraulic system of claim 12, wherein the combining valve is capable of selectively combining fluid flows from the first and second circuits during simultaneous operation of the swing motor, first travel motor, first linear actuator, second linear actuators, and third linear actuator.

14. The hydraulic system of claim 1, wherein the combining valve is a solenoid-operated variable-position valve that is spring biased from a flow-passing first position toward a flow-blocking second position.

15. The hydraulic system of claim 1, wherein the combining valve includes:
a first solenoid-operated variable-position valve associated with discharge passages of the first and second circuits; and
a second solenoid-operated variable-position valve associated with intake passages of the first and second circuits.

16. The hydraulic system of claim 1, wherein the combining valve is a solenoid-operated variable-position valve that is movable between a first position at which fluid is allowed to flow between a first passage of the first circuit and a first passage of the second circuit and between a second passage of the first circuit and a second passage of the second, a second position at which fluid is allowed to flow between the first passage of the first circuit and the second passage of the second circuit and between the second passage of the first circuit and the first passage of the second circuit, and a third position at which fluid flow through the combining valve is inhibited.

17. A hydraulic system, comprising:
a first circuit fluidly connecting an over-center variable-displacement first pump to an over-center variable-displacement swing motor in a closed-loop manner;
a second circuit fluidly connecting an over-center variable-displacement second pump to a fixed-displacement first travel motor and a first linear tool actuator in a parallel closed-loop manner;
a combining valve configured to selectively fluidly connect the first circuit to the second circuit;
a third circuit fluidly connecting an over-center variable-displacement third pump to tandem-operating second linear tool actuators and to a fixed-displacement second travel motor in a parallel closed-loop manner;
a fourth circuit fluidly connecting an over-center variable-displacement fourth pump to a third linear tool actuator in closed-loop manner;
at least a first metering valve associated with the swing motor;
at least a second metering valve associated with the first linear tool actuator;
at least a third metering valve associated with the first travel motor;
at least a fourth metering valve associated with the second linear tool actuators; and
at least a fifth metering valve associated with the second travel motor,
wherein:
the fourth circuit is a meterless circuit;
each of the swing motor, first travel motor, first linear actuator, second linear actuators, and third linear actuator are simultaneously operable; and
the combining valve is capable of selectively combining fluid flows from the first and second circuits during simultaneous operation of the swing motor, first travel motor, first linear actuator, second linear actuators, and third linear actuator.

18. A method of operating a hydraulic system, comprising:
pressurizing fluid with a first pump and a second pump;
directing fluid from the first pump to a swing motor and from the swing motor back to the first pump via a closed-loop first circuit;
directing fluid from the second pump to a first linear actuator and to a first travel motor in parallel and from the first linear actuator and travel motor back to the second pump via a closed-loop second circuit; and
selectively combining fluid from the first circuit with fluid from the second circuit.

19. The method of claim 18, further including:
pressurizing fluid with a third pump and a fourth pump;
directing fluid from the third pump to tandem-operating second linear actuators and to a second travel motor in parallel and from the second linear actuators and the second travel motor back to the third pump in a closed-loop manner; and
directing fluid from the fourth pump to a third linear actuator in a closed-loop manner.

20. The method of claim 19, further including selectively metering fluid into only the swing motor, the first linear actuator, the first travel motor, the second linear actuators, and the second travel motor.
